(19) United States
(12) Patent Application Publication
(10) Pub. No.: US 2026/0119927 A1
(43) Pub. Date: Apr. 30, 2026

(54) COMPUTER-IMPLEMENTED METHODS FOR TRAVERSING AN N-ARY TREE SIMULATING A QUANTUM CIRCUIT HAVING MID-CIRCUIT MEASUREMENT(S)

(71) Applicant: XANADU QUANTUM TECHNOLOGIES INC., Toronto (CA)

(72) Inventor: Vincent MICHAUD-RIOUX, Montréal (CA)

(21) Appl. No.: 18/896,995

(22) Filed: Sep. 26, 2024

(51) Int. Cl. G06N 10/20; G06F 16/22

(52) U.S. Cl. CPC G06N 10/20; G06F 16/2246

(57) ABSTRACT

There is described a method for traversing an N-ary tree simulating a quantum circuit, the method generally having: from a first internal node, traversing the tree towards a first leaf node, including storing, on a memory, a state vector SV₁ at the first leaf node, and a terminal measurement TM₁ associated to the state vector SV₁; from the first leaf node, traversing the tree back and towards a second leaf node, including: clearing, from the memory, the state vector SV₁; and storing a state vector SV₂ at the second leaf node, and a terminal measurement TM₂ associated to the state vector SV₂; and from the second leaf node, traversing the tree towards a second internal node, including: storing a combined terminal measurement TM₁₊₂ based on the terminal measurements TM₁ and TM₂; clearing the state vector SV₂; and storing a state vector SV₃ at the second internal node.

### FIELD

The improvements generally relate to the field of simulating quantum circuits using classical computing means, and more specifically relate to simulating mid-circuit measurements occurring in such quantum circuits.

### BACKGROUND

A quantum circuit generally includes quantum gate layers and a terminal measurement layer. When initial quantum states are inputted into an upstream one of the quantum gate layers, the quantum states are modified, and so forth, until the quantum states reach the terminal measurement layer where final quantum states are ultimately measured. In some situations, the quantum states are measured within the quantum circuit, i.e., between the quantum gate layers. These types of intermediate measurements are referred to as mid-circuit measurements (MCMs), and can be performed at mid-circuit measurement layers interspersed between some or all of the quantum gate layers. In some situations, it can be desirable to design dynamic quantum circuits that can be conditioned on the outcomes of the mid-circuit measurements. However, there exists a challenge in determining where to include such mid-circuit measurement layers within a given quantum circuit, and/or whether the mid-circuit measurements that are actually measured on a given quantum circuit meet expectations. Accordingly, mid-circuit measurement simulations can be desirable. Although existing mid-circuit measurement simulations are satisfactory to a certain degree, there remains room for improvement.

### SUMMARY

Simulating quantum circuits using classical computing means can bring a number of practical computational problems. More specifically, it is known that classical registers have memory register elements which can take the value 0 or 1. Accordingly, a classical register state of n bits can be represented using an n-dimensional vector taking the discrete values 0 and 1. In quantum circuits, a quantum n-qubit register is not limited to n bits, but can be rather represented using a 2ⁿ-dimensional vector with complex elements (e.g., 1/√2+j/√2), hereinafter referred to as a “state vector.” As this is one reason why quantum computers can do things classical computers cannot, this disparity is also a reason why quantum computers are difficult to simulate using classical means. For instance, while a quantum register with 20 qubits requires 16 MB to be represented with double-precision floating point numbers, a mere increase to 30 qubits increases the memory requirements a thousand-fold to 16 GB, which most modern computers can barely hold in memory. The addition of another 10 qubits results in a memory demand of 16 TB, which requires supercomputers to simply store in memory. It is therefore crucial to manipulate state vectors as little and as efficiently as possible while keeping the number of state vector copies to a minimum.

To simulate MCMs, state-of-the-art quantum simulators typically implement state-vector or tensor-network methods to compute the state of the device right before measurements and then measure either using analytical formulae or by sampling from the probability distribution corresponding to the wavefunction. This contrasts with real device execution which is intrinsically stochastic, yielding a single sample for each end-to-end execution of a circuit.

One issue with simulating dynamic circuits is that MCMs are non-unitary operations, which do not qualify as bona fide quantum gates. Since they cannot be simulated as such, it is necessary to use mathematical tricks to emulate MCMs while maintaining unitarity, such as the deferred measurement technique (rooted in the deferred measurement principle). These techniques have the drawback of requiring computational and memory resources that are exponential in the number of MCMs, preventing the simulation of even the smallest circuit beyond a couple of dozen MCMs. On the other hand, it is possible to simulate the circuit dynamically one shot at a time (referred to herein as the “shot-by-shot” technique), similar to how a real device might be executed, but this has the drawback of needing to simulate the same circuit thousands or millions of times.

Given the above, there is a need for more computationally efficient methods of simulating MCMs.

In accordance with a first aspect of the present disclosure, there is provided a computer-implemented method for traversing an N-ary tree simulating a quantum circuit, the N-ary tree having a root node A, internal nodes B and C, and leaf nodes D and E child to internal node B, the root node A and the internal nodes B and C corresponding to mid-circuit measurements of the quantum circuit and the leaf nodes D and E corresponding to terminal measurements of the quantum circuit, the method comprising: from the root node A, traversing the N-ary tree through the internal node B towards the leaf node D, including storing, on a memory of a computing device, a state vector SV_{A} at root node A, a state vector SV_{B} at internal node B, a state vector SV_{D} at leaf node D, and a terminal measurement TM_{D} associated to the state vector SV_{D}; from the leaf node D, traversing the N-ary tree through the internal node B towards leaf node E, including: clearing, from the memory, the state vector SV_{D}; and storing, on the memory, a state vector SV_{E} at leaf node E, and a terminal measurement TM_{E} associated to the state vector SV_{E}; and from the leaf node E, traversing the N-ary tree through the internal node B and root node A towards internal node C, including: storing, on the memory, a combined terminal measurement TM_{D+E} corresponding to a combination of the terminal measurements TM_{D} and TM_{E}; clearing, from the memory, the state vectors SV_{E} and SV_{B}; and storing, on the memory, a state vector SV_{C} at internal node C.

Further in accordance with the first aspect, the method can for example further comprise, after said storing the combined terminal measurement TM_{D+E}, clearing, from the memory, the terminal measurements TM_{D} and TM_{E}.

Still further in accordance with the first aspect, the N-ary tree can for example have leaf nodes F and G child to internal node C, the method further comprising: from the internal node C, traversing the N-ary tree towards the leaf node F, including: storing, on the memory, a state vector SV_{F} at leaf node F, and a terminal measurement of TM_{F} associated to the state vector SV_{F}.

Still further in accordance with the first aspect, the method can for example further comprise: from the leaf node F, traversing the N-ary tree through the internal node C towards leaf node G, including: clearing, from the memory, the state vector SV_{F}; and storing, on the memory, a state vector SV_{G} at leaf node G, and a terminal measurement of TM_{G} associated to the state vector SV_{G}.

Still further in accordance with the first aspect, said traversing can for example include: storing, on the memory, a combined terminal measurement TM_{F+G} corresponding to a combination of the terminal measurements TM_{F} and TM_{G}; and clearing, from the memory, the state vectors SV_{G} and SV_{C}.

Still further in accordance with the first aspect, said traversing can for example include: storing, on the memory, a combined terminal measurement TM_{D+E+F+G} corresponding to a combination of the combined terminal measurements TM_{D+E} and TM_{F+G}; and clearing, from the memory, the state vector SV_{A}.

Still further in accordance with the first aspect, the quantum circuit can for example process n qubits, each state vector representing a 2ⁿ-dimensional vector to be stored on the memory, each state vector including complex numbers having real and imaginary parts.

Still further in accordance with the first aspect, the N-ary tree can for example have a depth n_{MCM} of 2, a number of state vectors simultaneously stored on the memory being 3 or below.

Still further in accordance with the first aspect, the N-ary tree can for example further include one or more additional layers of internal nodes, thereby leaving the N-ary tree with a depth n_{MCM}, a number of state vectors simultaneously stored on the memory being n_{MCM}+1 or below.

Still further in accordance with the first aspect, the method can for example further comprise inputting a plurality of samples at the root node, each of the root node and the internal nodes having a respective left and right count determining which sample(s) of the plurality of samples is(are) routed towards which child nodes.

Still further in accordance with the first aspect, when the terminal measurements are expectation values, each combination can for example correspond to a weighted sum, the weighted sum based on the left and right count of the corresponding node.

Still further in accordance with the first aspect, when the terminal measurements are counts, each combination can for example correspond to a direct sum.

Still further in accordance with the first aspect, the method can for example further comprise: upon determining that one of the root node A, the internal node B, and the internal node C receives a null count towards one of the child nodes, omitting the traversing of the N-ary tree through the child node and traversing the N-ary tree through the other one of the child nodes.

Still further in accordance with the first aspect, the N-ary tree can for example be a binary tree.

In accordance with a second aspect of the present disclosure, there is provided a computing device for traversing an N-ary tree simulating a quantum circuit, the N-ary tree having a root node A, internal nodes B and C, and leaf nodes D and E child to internal node B, the root node A and the internal nodes B and C corresponding to mid-circuit measurements of the quantum circuit and the leaf nodes D and E corresponding to terminal measurements of the quantum circuit, the computing device comprising: a processor; and a computer-readable memory having stored thereon instructions which when executed by the processor perform the steps of: from the root node A, traversing the N-ary tree through the internal node B towards the leaf node D, including storing, on a memory of a computing device, a state vector SV_{A} at root node A, a state vector SV_{B} at internal node B, a state vector SV_{D} at leaf node D, and a terminal measurement TM_{D} associated to the state vector SV_{D}; from the leaf node D, traversing the N-ary tree through the internal node B towards leaf node E, including: clearing, from the memory, the state vector SV_{D}; and storing, on the memory, a state vector SV_{E} at leaf node E, and a terminal measurement TM_{E} associated to the state vector SV_{E}; and from the leaf node E, traversing the N-ary tree through the internal node B and root node A towards internal node C, including: storing, on the memory, a combined terminal measurement TM_{D+E} corresponding to a combination of the terminal measurements TM_{D} and TM_{E}; clearing, from the memory, the state vectors SV_{E} and SV_{B}; and storing, on the memory, a state vector SV_{C} at internal node C.

In accordance with a third aspect of the present disclosure, there is provided a computer-implemented method for traversing an N-ary tree simulating a quantum circuit, the N-ary tree having a root node, a plurality of layers of internal nodes, and leaf nodes child to a downstream one of the layers of internal nodes, the root node A and the plurality of layers of internal nodes corresponding to a plurality of mid-circuit measurement layers of the quantum circuit, and the leaf nodes corresponding to terminal measurements of the quantum circuit, the method comprising: from a first internal node of a downstream one of the layers of internal nodes, traversing the N-ary tree towards a first one of the leaf nodes, including storing, on a memory of a computing device, a state vector SV₁ at the first one of the leaf nodes, and a terminal measurement TM₁ associated to the state vector SV₁; from the first one of the leaf nodes, traversing the N-ary tree through the first internal node towards a second one of the leaf nodes, including: clearing, from the memory, the state vector SV₁; and storing, on the memory, a state vector SV₂ at the second one of the leaf nodes, and a terminal measurement TM₂ associated to the state vector SV₂; and from the second one of the leaf nodes, traversing the N-ary tree through the first internal node towards a second internal node of the downstream one of the layers of internal nodes, including: storing, on the memory, a combined terminal measurement TM₁₊₂ corresponding to a combination of the terminal measurements TM₁ and TM₂; clearing, from the memory, the state vector SV₂; and storing, on the memory, a state vector SV₃ at the second internal node.

Further in accordance with the third aspect, the quantum circuit can for example process n qubits, each state vector represents a 2ⁿ-dimensional vector to be stored on the memory, each state vector including complex numbers having real and imaginary parts.

Still further in accordance with the third aspect, the N-ary tree can for example have a depth n_{MCM}, corresponding to a number of edges from the root node to one of the leaf nodes, a number of state vectors simultaneously stored on the memory being n_{MCM}+1 or below.

Still further in accordance with the third aspect, the method can for example further comprise: inputting a plurality of samples at the root node, each of the root node and the internal nodes having a respective left and right count determining which sample(s) of the plurality of samples is(are) routed towards which child nodes.

Still further in accordance with the third aspect, when the terminal measurements are expectation values, each combination can for example correspond to a weighted sum, the weighted sum based on the left and right count of the corresponding node.

Still further in accordance with the third aspect, when the terminal measurements are counts, each combination can for example correspond to a direct sum.

In accordance with a fourth aspect of the present disclosure, there is provided a method for traversing an N-ary tree simulating a quantum circuit, the method generally having: from a first internal node, traversing the tree towards a first leaf node, including storing, on a memory, a state vector SV₁ at the first leaf node, and a terminal measurement TM₁ associated to the state vector SV₁; from the first leaf node, traversing the tree back and towards a second leaf node, including: clearing, from the memory, the state vector SV₁; and storing a state vector SV₂ at the second leaf node, and a terminal measurement TM₂ associated to the state vector SV₂; and from the second leaf node, traversing the tree towards a second internal node, including: storing a combined terminal measurement TM₁₊₂ based on the terminal measurements TM₁ and TM₂; clearing the state vector SV₂; and storing a state vector SV₃ at the second internal node.

In accordance with a fifth aspect of the present disclosure, there is provided a computer-implemented method for simulating a quantum circuit, the method comprising: using a computing device, generating an N-ary tree representing the quantum circuit, the N-ary tree having at least a root node A, internal nodes B and C, and leaf nodes D and E child to internal node B, said representing including associating the root node A to a first mid-circuit measurement layer of the quantum circuit, associating the internal nodes B and C to a second mid-circuit measurement layer of the quantum circuit, and associating the leaf nodes D and E to a terminal measurement layer of the quantum circuit; and using the computing device, traversing the N-ary tree, said traversing including, from the root node A, traversing the N-ary tree through the internal node B towards the leaf node D, including storing, on a memory of the computing device, a state vector SV_{A} at root node A, a state vector SV_{B} at internal node B, a state vector SV_{D} at leaf node D, and a terminal measurement TM_{D} associated to the state vector SV_{D}.

Further in accordance with the fifth aspect of the present disclosure, the method can further comprise, from the leaf node D, traversing the N-ary tree through the internal node B towards leaf node E, including: clearing, from the memory, the state vector SV_{D}; and storing, on the memory, a state vector SV_{E} at leaf node E, and a terminal measurement TM_{E} associated to the state vector SV_{E}; and

Still further in accordance with the fifth aspect of the present disclosure, the method can further comprise, from the leaf node E, traversing the N-ary tree through the internal node B and root node A towards internal node C, including: storing, on the memory, a combined terminal measurement TM_{D+E} corresponding to a combination of the terminal measurements TM_{D} and TM_{E}; clearing, from the memory, the state vectors SV_{E} and SV_{B}; and storing, on the memory, a state vector SV_{C} at internal node C.

Further in accordance with the fifth aspect, the method can for example further comprise, after said storing the combined terminal measurement TM_{D+E}, clearing, from the memory, the terminal measurements TM_{D} and TM_{E}.

Still further in accordance with the fifth aspect, the N-ary tree can for example have leaf nodes F and G child to internal node C, the method further comprising: from the internal node C, traversing the N-ary tree towards the leaf node F, including: storing, on the memory, a state vector SV_{F} at leaf node F, and a terminal measurement of TM_{F} associated to the state vector SV_{F}.

Still further in accordance with the fifth aspect, the method can for example further comprise: from the leaf node F, traversing the N-ary tree through the internal node C towards leaf node G, including: clearing, from the memory, the state vector SV_{F}; and storing, on the memory, a state vector SV_{G} at leaf node G, and a terminal measurement of TM_{G} associated to the state vector SV_{G}.

Still further in accordance with the fifth aspect, said traversing can for example include: storing, on the memory, a combined terminal measurement TM_{F+G} corresponding to a combination of the terminal measurements TM_{F} and TM_{G}; and clearing, from the memory, the state vectors SV_{G} and SV_{C}.

Still further in accordance with the fifth aspect, said traversing can for example include: storing, on the memory, a combined terminal measurement TM_{D+E+F+G} corresponding to a combination of the combined terminal measurements TM_{D+E} and TM_{F+G}; and clearing, from the memory, the state vector SV_{A}.

Still further in accordance with the fifth aspect, the quantum circuit can for example process n qubits, each state vector representing a 2ⁿ-dimensional vector to be stored on the memory, each state vector including complex numbers having real and imaginary parts.

Still further in accordance with the fifth aspect, the N-ary tree can for example have a depth n_{MCM} of 2, a number of state vectors simultaneously stored on the memory being 3 or below.

Still further in accordance with the fifth aspect, the N-ary tree can for example further include one or more additional layers of internal nodes, thereby leaving the N-ary tree with a depth n_{MCM}, a number of state vectors simultaneously stored on the memory being n_{MCM}+1 or below.

Still further in accordance with the fifth aspect, the method can for example further comprise inputting a plurality of samples at the root node, each of the root node and the internal nodes having a respective left and right count determining which sample(s) of the plurality of samples is(are) routed towards which child nodes.

Still further in accordance with the fifth aspect, when the terminal measurements are expectation values, each combination can for example correspond to a weighted sum, the weighted sum based on the left and right count of the corresponding node.

Still further in accordance with the fifth aspect, when the terminal measurements are counts, each combination can for example correspond to a direct sum.

Still further in accordance with the fifth aspect, the method can for example further comprise: upon determining that one of the root node A, the internal node B, and the internal node C receives a null count towards one of the child nodes, omitting the traversing of the N-ary tree through the child node and traversing the N-ary tree through the other one of the child nodes.

Still further in accordance with the fifth aspect, the N-ary tree can for example be a binary tree.

All technical implementation details and advantages described with respect to a particular aspect of the present invention are self-evidently mutatis mutandis applicable for all other aspects of the present invention.

Many further features and combinations thereof concerning the present improvements will appear to those skilled in the art following a reading of the instant disclosure.

### DESCRIPTION OF THE FIGURES

In the figures,

FIG. 1 is a schematic view of an example of a quantum circuit, shown with a first quantum gate layer, a first mid-circuit measurement layer, a second quantum gate layer, a second mid-circuit measurement layer, a third quantum gate layer, and a terminal measurement layer, in accordance with one or more embodiments;

FIG. 2 is a schematic view of an example of a binary tree simulating the quantum circuit of FIG. 1, showing a deferred measurement technique, in accordance with the prior art;

FIG. 3 is a schematic view of an example of a binary tree simulating the quantum circuit of FIG. 1, showing traversal using a tree traversal technique proposed herein, in accordance with one or more embodiments;

FIG. 4 is a table showing state vector(s) and terminal measurement(s) being stored on a memory of a computing device and/or cleared from the memory at each step of the tree traversal technique proposed in FIG. 3, in accordance with one or more embodiments;

FIG. 5 is a graph showing time as a function of number of mid-circuit measurements for the tree traversal technique proposed in FIG. 3, for a deferred measurement technique, and for a one-shot measurement technique, in accordance with one or more embodiments;

FIG. 6 is a flow chart of a method for traversing an N-ary tree simulating a quantum circuit, in accordance with one or more embodiments;

FIG. 7 is a schematic view of an example of a computing device, in accordance with one or more embodiments;

FIG. 8 is a schematic view of an example of a binary tree showing terminal measurements and a first combination example, in accordance with one or more embodiments;

FIG. 9 is a schematic view of an example of a binary tree showing terminal measurements and a second combination example, in accordance with one or more embodiments;

FIG. 10 is a schematic view of an example of a binary tree routing ten samples, with one sample routed to internal node B and nine samples routed to internal node C, in accordance with one or more embodiments;

FIG. 11 is a schematic view of an example of a binary tree routing ten samples, with zero samples routed to internal node B and ten samples routed to internal node C, in accordance with one or more embodiments; and

FIG. 12 is a schematic view of an example of a binary tree in which outcomes for some of the internal nodes are post-selected, thereby reducing computation requirements for traversing the binary tree, in accordance with one or more embodiments.

### DETAILED DESCRIPTION

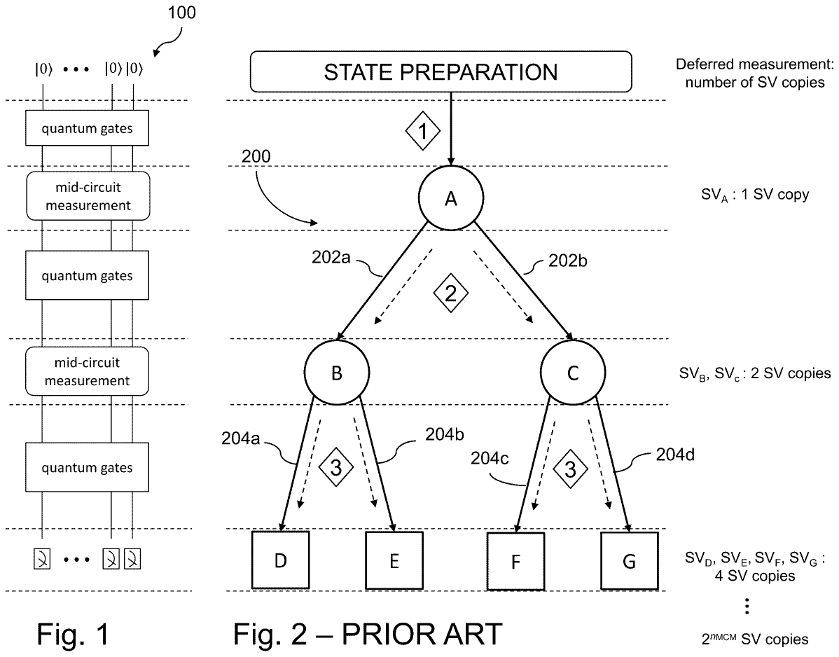

FIG. 1 shows an example of a quantum circuit 100, in accordance with an embodiment. As depicted, the quantum circuit has a first quantum gate layer, a first mid-circuit measurement layer, a second quantum gate layer, a second mid-circuit measurement layer, a third quantum gate layer, and a terminal measurement layer. The first quantum gate layer, the first mid-circuit measurement layer, the second quantum gate layer, the second mid-circuit measurement layer, the third quantum gate layer, and the terminal measurement layer are arranged in series in this example. More specifically, the first mid-circuit measurement layer is immediately downstream from the first quantum gate layer, the second quantum gate layer is immediately downstream from the first mid-circuit measurement layer, the second mid-circuit measurement layer is immediately downstream from the second quantum gate layer, the third quantum gate layer is immediately downstream from the second mid-circuit measurement layer, and the terminal measurement layer is immediately downstream from the third quantum gate layer.

During use, initial quantum states are routed through the first quantum gate layer which can modify some or all of the initial quantum states to obtain first intermediate quantum states. The first intermediate quantum states outputted from the first quantum gate layer are then measured at the first mid-circuit measurement layer, which can provide full or partial information concerning the first intermediate quantum states. Once measured, the first intermediate quantum states are then routed through the second quantum gate layer. The second quantum gate layer can modify some or all of the first intermediate quantum states to obtain second intermediate quantum states. The second intermediate quantum states outputted from the second quantum gate layer are then measured at the second mid-circuit measurement layer, which can provide full or partial information concerning the second intermediate quantum states. Once measured, the second intermediate quantum states are then routed through the third quantum gate layer. The third quantum gate layer can modify some or all of the second intermediate quantum states to obtain final quantum states. Ultimately, the final quantum states are measured at the terminal measurement layer.

It is intended that the quantum circuit 100 described with reference to FIG. 1 is meant to be exemplary only. For instance, in some other embodiments, the quantum circuit can have fewer or more than three quantum gate layers and/or fewer or more than two mid-circuit measurement layers. For instance, in some embodiments, the quantum circuit has a first number x₁ of quantum gate layers interspersed with a second number x₂ of mid-circuit measurements layers. The first number x₁ can denote an integer greater than unity, whereas the second number x₂ can denote an integer smaller than the number x₁ according to the relation x₂≤x₁−1. In any event, the quantum gates of one of the quantum gate layers can be similar or dissimilar to the quantum gates of another one of the quantum gate layers, depending on the embodiment. As such, the quantum circuit can be any suitable type of quantum circuit. Moreover, it is meant that the number of initial quantum states inputted to the quantum circuit can vary from one embodiment to another. For instance, although FIG. 1 shows a set of three initial quantum states and a set of three final quantum states, it is intended that the quantum circuit can receive one, two, or more than three initial quantum states, which may lead to one, two, or more than three final quantum states, respectively.

As discussed above, there exists a challenge in determining where to include the mid-circuit measurement layer(s) within a given quantum circuit, and/or whether the mid-circuit measurements that are actually measured on a given quantum circuit satisfactorily meet expectations. Accordingly, mid-circuit measurement simulations are desirable. However, simulating quantum circuits using classical computing means can bring a number of practical computational problems, and more specifically memory management challenges. More specifically, it is known that classical registers have memory register elements which can take the value 0 or 1. Accordingly, a classical register state of n bits can be represented using an n-dimensional vector taking the discrete values 0 and 1. In quantum circuits, a quantum n-qubit register is not limited to n bits, but can be rather represented using a 2ⁿ-dimensional vector referred to as a state vector which can have complex elements (e.g., 1/√2+j/√2). As this is one reason why quantum computers can do things classical computers cannot, this disparity is also a reason why quantum computers are difficult to simulate using classical means. For instance, while a quantum register with 20 qubits requires 16 MB to be represented with double-precision floating point numbers, a mere increase to 30 qubits increases the memory requirements a thousand-fold to 16 GB, which most modern computers can barely hold in memory. The addition of another 10 qubits results in a memory demand of 16 TB, which requires supercomputers to simply store in memory. It is therefore crucial to manipulate state vectors as little and as efficiently as possible while keeping the number of state vector copies to a minimum to relax the memory requirements of the classical computing device. In this disclosure, the classical computing device is referred to simply as “the computing device.” The computing device typically has a processor and a computer-readable memory (hereinafter “the memory”) which has stored thereon instructions that when executed by the processor perform a set of instructions and/or steps.

Proposed herein is a method to simulate quantum circuits using N-ary trees such as binary trees traversed using the computing device. Indeed, dynamic circuit execution is akin to traversing a binary tree where each MCM corresponds to a node and groups of quantum logic gates between the MCMs correspond to edges. This can be generalised to a generic tree graph to handle MCMs not made in the computational basis or to simulate perturbations of the system (e.g., noise). Each MCM is represented in the tree as a node, with the branches of that node corresponding to possible sampling outcomes. For example, for an MCM with two sampling outcomes (e.g., Pauli-Z basis MCMs, a.k.a. computational basis MCMs), there would be two branches, each corresponding to one of the two sampling outcomes. When the simulation reaches the end of the first circuit segment, the sampling outcomes are randomly generated and corresponding counts are produced (i.e., a count for each branch or possible sampling outcome). In this disclosure, the term “traverse” refers to a computing device going through a set of calculation steps predefined or pre-programmed in accordance with an N-ary tree. FIG. 2 shows an example of a binary tree. As depicted, the binary tree 200 has a root node A, internal nodes B and C, leaf nodes D and E child to internal node B, and leaf nodes F and G child to internal node C. More specifically, in this example, root node A corresponds to the first mid-circuit measurement layer, edges 202a and 202b correspond to the second quantum gate layer, internal nodes B and C correspond to the second mid-circuit measurement layer, edges 204a, 204b, 204c, and 204d correspond to the third quantum gate layer, and the leaf nodes D, E, F, and G correspond to terminal measurements of the quantum circuit, where the final quantum states are measured.

Furthermore, FIG. 2 schematically shows the simulation of the quantum circuit 100 of FIG. 1 using a conventional technique known as the deferred measurement technique. In FIG. 2, the deferred measurement technique is depicted in the form of a tree traversal method for illustrative purposes, such that direct comparisons can be made to the tree traversal technique proposed herein. As is understood by those of ordinary skill in the art, the deferred measurement technique is not typically considered to be a type of tree traversal technique. As shown, the binary tree 200 is traversed linearly, via dashed lines extending from top to bottom, with the internal nodes B and C being traversed simultaneously or sequentially, reaching the terminal nodes D, E, F, and G simultaneously or sequentially. In practice, a first state vector is stored on the memory at root node A, two state vectors are stored on the memory at the internal nodes B and C, then four state vectors are stored on the memory at leaf nodes D, E, F, and G. This is highlighted by the number of SV (i.e., state vector) copies on the right-hand side of the figure. Even if the state vector(s) of the previous layer are cleared from the memory when no longer useful, this technique indubitably leads to a total of four vector states requiring to be stored on the memory simultaneously in order to reach the leaf nodes and end the simulation. Now, this binary tree is simple as it encompasses only two layers of nodes (i.e., two MCMs), with the first layer encompassing the root node A and the second layer encompassing the internal nodes B and C. However, it can be shown that the memory requirements of this deferred measurement technique are defined by the relation 2^{nMCM}, where n_{MCM} denotes a depth of the quantum circuit. The depth of the quantum circuit is defined as the number of mid-circuit measurement layers. Accordingly, for a depth of n_{MCM}=2, as illustrated, a maximal number of 4 state vectors need to be stored on the memory simultaneously, for a depth of n_{MCM}=3, a maximal number of 8 state vectors need to be stored on the memory simultaneously, for a depth of n_{MCM}=5, a maximal number of 32 state vectors need to be stored on the memory simultaneously, and so forth. In addition to those state vectors, an equivalent number of terminal measurements TM also need to be stored on the memory simultaneously. It was found that such a technique was computationally too demanding on existing computing devices. Moreover, this technique may lead to computing times that are impractical, especially when the quantum circuits to simulate are complex.

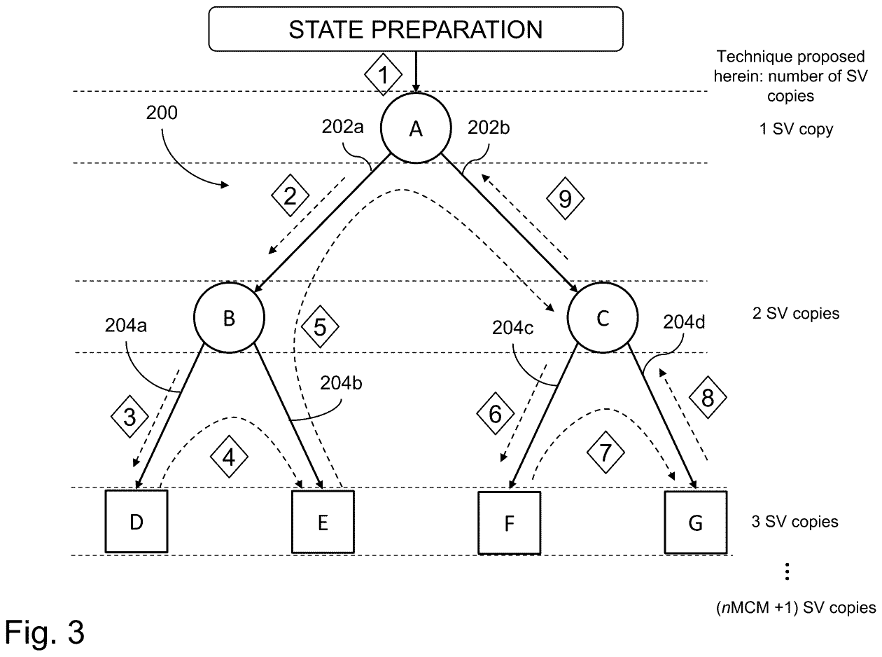

FIG. 3 schematically shows a method for traversing the binary tree 200 in a manner which can address at least some of the memory management challenges articulated above. More specifically, as will be described below, the technique proposed herein does not go for the top-to-bottom tree traversing path shown in FIG. 2. Instead, the technique proposed herein traverses the tree straight to a first one of the leaf nodes, where a first terminal measurement is made, at which point the traversing involves going back up the binary tree and then straight through a second one of the leaf nodes. At this stage, the terminal measurements of the two leaf nodes are combined with one another, which can allow the memory allocated to the state vectors and the terminal measurements associated with the two leaf nodes to be cleared. Then, the tree traversal goes back up the binary tree and then straight through another set of leaf nodes, and so forth. In this architecture, since terminal measurements are combined with one another on the go, some state vectors and terminal measurements that are no longer needed can be cleared from the memory, which alleviate the memory requirements on the computing device.

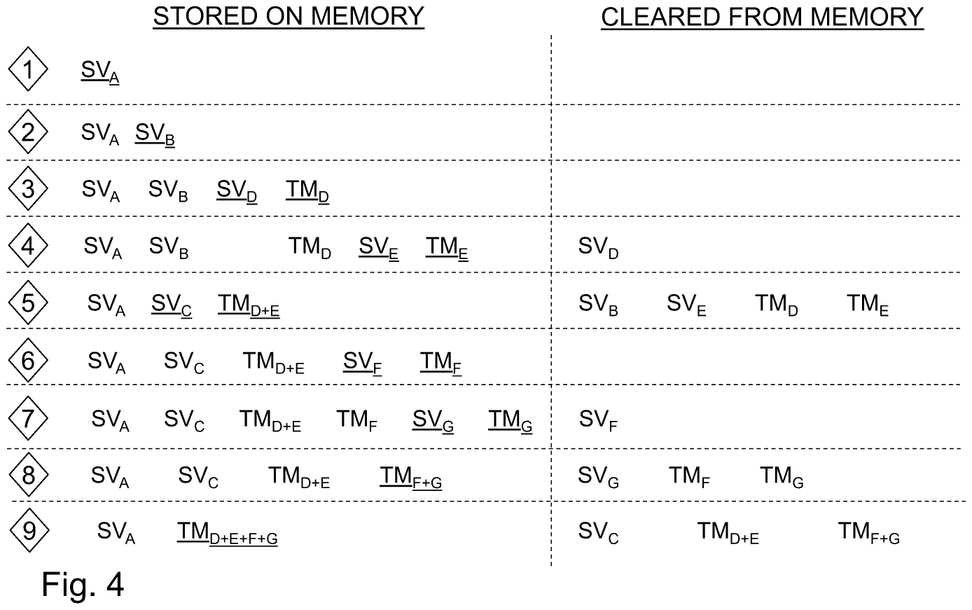

FIG. 4 shows what state vector(s) and/or terminal measurement(s) are stored on the memory and/or cleared from the memory at each step of the tree traversal depicted in FIG. 3. As shown, nowhere is there more than three state vectors simultaneously stored on the memory. Accordingly, for the proposed tree traversal technique, the memory requirements are defined by the relation n_{MCM}+1, where n_{MCM} denotes the depth of the quantum circuit. As discussed above, the depth n_{MCM} is defined as the number of mid-circuit measurement layers. Accordingly, for a depth of n_{MCM}=2, as depicted, a maximal number of 3 state vectors need to be stored on the memory simultaneously, for a depth of n_{MCM}=3, a maximal number of 4 state vectors need to be stored on the memory simultaneously, for a depth of n_{MCM}=5, a maximal number of 6 state vectors need to be stored on the memory simultaneously, and so forth. In addition to the state vectors that are cleared from the memory after they are not longer useful, terminal measurement can also be cleared from the memory when they have been combined with other terminal measurements. The proposed technique was found to be computationally a lot less demanding on existing computing devices, and therefore allowed more complex quantum circuits to be simulated within practical time frames using readily available practical computing devices.

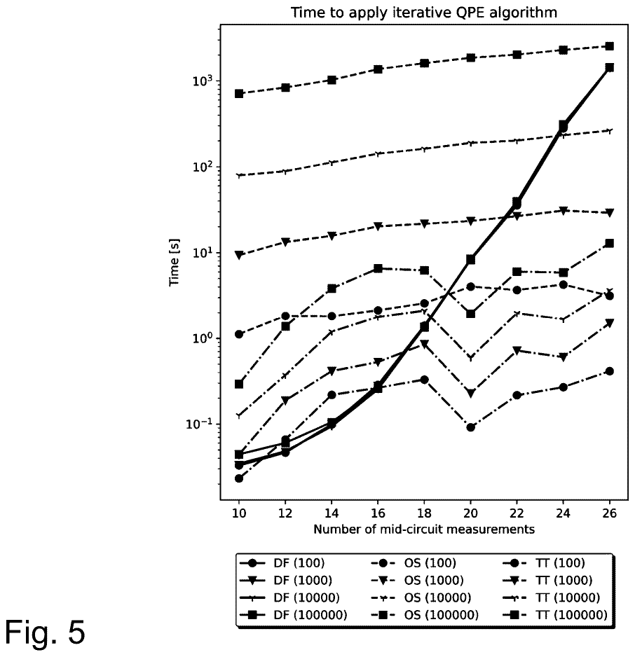

Indeed, FIG. 5 shows the performance of three quantum circuit simulation techniques when different numbers of samples (e.g., 100, 1000, 10000, 100000) are simulated. More specifically, the performance is quantified by the computing time required to simulate a quantum circuit having different mid-circuit measurement layers. The deferred measurement technique is denoted by the acronym DF, the shot-by-shot measurement technique is denoted by the acronym OS, and the tree traversal technique proposed herein is denoted by the acronym TT. As illustrated, the computing times associated with the tree traversal technique TT are always lower than the computing times associated with the OS technique and are lower than the computing times associated with the DF technique for larger circuit depths. Moreover, the acute reader will notice that the computing time associated with the DF technique does not appear to converge for a high number of mid-circuit measurements. As a result, the tree traversal technique TT proposed herein appears to perform better with increasing sample length and increasing mid-circuit measurement numbers compared to the DF and OS techniques. The computing device running the tree traversal technique TT proposed herein thus functions better than computing devices running the other DF and OS techniques. Indeed, the tree traversal technique TT can have several advantages:
compared with the naive dynamical OS implementation, it significantly reduces the overheads and duplicate work associated with running the same circuit many times;
compared with the DF implementation, it reduces memory usage exponentially, as well as computational cost in the large MCM number limit; and
static and dynamic pruning of the tree are key ingredients in enhancing the above performances, as discussed in greater detail below.

The tree traversal technique TT can be provided in the form of a software implementation in pure Python within the PennyLane® library. The advantages listed above are emphasized by FIG. 5, reporting timings for the iterative quantum phase estimation algorithm. For each iteration of the algorithm, a mid-circuit measurement is made which brings about dynamic circuit execution. The benchmark focuses on relatively low shot counts (≤100,000) where the shot-by-shot (also referred to as one-shot (OS)) implementation can be competitive, and runs iterative quantum phase estimation (IQPE)—a quantum circuit commonly studied in the field of quantum computing algorithms—for a varying number of iterations. Note that the OS and TT implementations scale sub-exponentially with respect to the number of iterations, with the TT implementation already faster than OS for 10 shots and two orders of magnitude faster for 10,000 shots. The situation only improves for TT as the number of shots gets into the 1 million to 10 million range (not shown), which is common in MCM simulations. By contrast, the DF algorithm is competitive in the few-iteration regime but quickly loses to TT (and OS) as the computational and memory burden increases exponentially with respect to the number of iterations (or MCMs).

It is understood that in the above illustrated examples, the N-ary tree is binary, i.e., N=2. However, it is understood that in other embodiments, the N-ary tree can be any other type of tree including embodiments where N=3, 4, 5 or greater. The performance described above with respect to binary tree would translate to any N-ary tree of greater N.

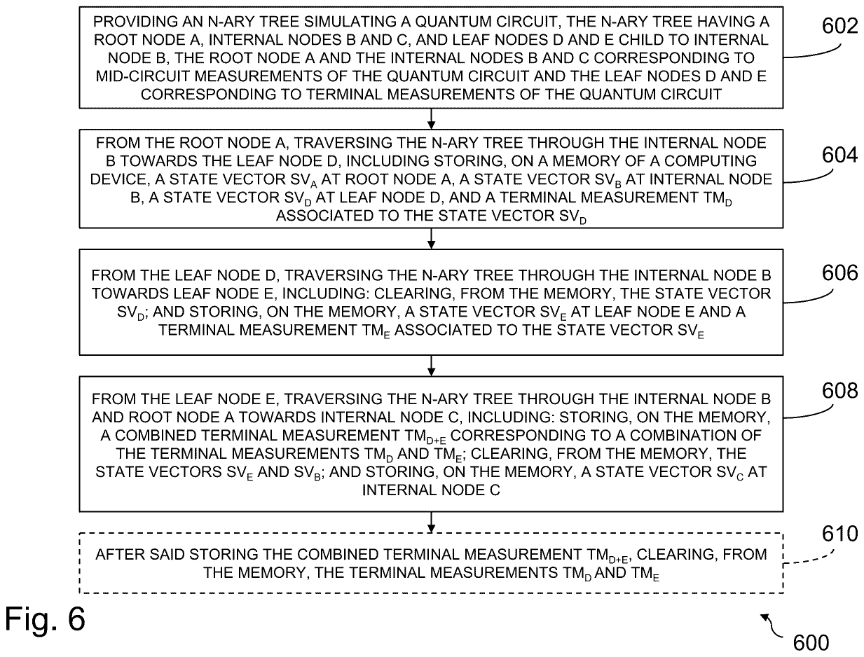

FIG. 6 shows a flow chart of a method 600 of traversing an N-ary tree simulating a quantum circuit, in accordance with an embodiment. In this embodiment, the method 600 is described with respect to the binary tree (i.e., N=2) shown and described with reference to FIG. 2.

More specifically, the method 600 includes a step 602 of providing an N-ary tree having a root node A, internal nodes B and C, and leaf nodes D and E child to internal node B. The root node A and the internal nodes B and C correspond to mid-circuit measurements of the quantum circuit whereas the leaf nodes D and E correspond to terminal measurements of the quantum circuit. As will be discussed below, the N-ary tree can also include leaf nodes F and G child to internal node C. In some other embodiments, the N-ary tree is not necessarily a binary tree. Moreover, the number of layers of nodes can be greater than two in some other embodiments. However, for ease of reading, a binary tree having a depth of n_{MCM}=2 such as the one illustrated in FIGS. 2 and 3 is referred to.

At step 604, from the root node A, the N-ary tree is traversed through the internal node B towards the leaf node D. The step 604 includes storing, on a memory of a computing device, a state vector SV_{A} at root node A, a state vector SV_{B} at internal node B, a state vector SV_{D} at leaf node D, and a terminal measurement TM_{D} associated to the state vector SV_{D}. With reference to the nomenclature shown in FIGS. 3 and 4, the step 604 encompasses the tree traversal steps labeled by diamonds numbered 1, 2, and 3.

At step 606, from the leaf node D, the N-ary tree is traversed through the internal node B towards leaf node E. The step 405 includes: clearing, from the memory, the state vector SV_{D}; and storing, on the memory, a state vector SV_{E} at leaf node E and a terminal measurement TM_{E} associated to the state vector SV_{E}. With reference to the nomenclature shown in FIGS. 3 and 4, the step 606 encompasses the tree traversal step labeled by diamond numbered 4.

At step 608, from the leaf node E, the N-ary tree is traversed through the internal node B and root node A towards internal node C. The step 608 includes: storing, on the memory, a combined terminal measurement TM_{D+E} corresponding to a combination of the terminal measurements TM_{D} and TM_{E}; clearing, from the memory, the state vectors SV_{E} and SV_{B}; and storing, on the memory, a state vector SV_{C} at internal node C.

At step 610, the terminal measurements TM_{D} and TM_{E} are cleared from the memory of the computing device after said storing the combined terminal measurement TM_{D+E}. With reference to the nomenclature shown in FIGS. 3 and 4, the steps 608 and 610 encompass the tree traversal step labeled by diamond numbered 5.

The method 600 can include another step in which, from the internal node C, the N-ary tree is traversed towards the leaf node F. This step can include: storing, on the memory, a state vector SV_{F} at leaf node F and a terminal measurement of TM_{F} associated to the state vector SV_{F}. With reference to the nomenclature shown in FIGS. 3 and 4, this step encompasses the tree traversal step labeled by diamond numbered 6.

The method 600 can include another step in which, from the leaf node F, the N-ary tree is traversed through the internal node C towards leaf node G. This step can include: clearing, from the memory, the state vector SV_{F}; and storing, on the memory, a state vector SV_{G} at leaf node G and a terminal measurement of TM_{G} associated to the state vector SV_{G}. With reference to the nomenclature shown in FIGS. 3 and 4, this step encompasses the tree traversal step labeled by diamond numbered 7.

The method 600 can include another step of: storing, on the memory, a combined terminal measurement TM_{F+G} corresponding to a combination of the terminal measurements TM_{F} and TM_{G}; and clearing, from the memory, the state vectors SV_{G} and SV_{C}. Additionally or alternatively, the terminal measurements TM_{F} and TM_{G} can be cleared from the memory of the computing device after said storing the combined terminal measurement TM_{F+G}. With reference to the nomenclature shown in FIGS. 3 and 4, this step encompasses the tree traversal step labeled by diamond numbered 8.

The method 600 can include another step of: storing, on the memory, a combined terminal measurement TM_{D+E+F+G} corresponding to a combination of the combined terminal measurements TM_{D+E} and TM_{F+G}; and clearing, from the memory, the state vector SV_{A}. Additionally or alternatively, the terminal measurements TM_{D+E} and TM_{F+G} can be cleared from the memory of the computing device after said storing the combined terminal measurement TM_{D+E+F+G}. With reference to the nomenclature shown in FIGS. 3 and 4, this step encompasses the tree traversal step labeled by diamond numbered 9.

As discussed above, it is intended that as the quantum circuit to be simulated processes n qubits, each state vector represents a 2ⁿ-dimensional vector to be stored on the memory. Each state vector can include complex numbers having real and imaginary parts. Accordingly, diligently combining terminal measurements when possible, and clearing state vectors and/or terminal measurements that are no longer useful on the go enables memory efficiency, which can in turn help with increasing the complexity of the quantum circuits to be simulated and/or reducing the memory requirements associated with each simulation. As discussed above, for an N-ary tree having a depth n_{MCM} of 2, the number of state vectors simultaneously stored on the memory is only 3 or below. Moreover, where the N-ary tree has one or more additional layers of internal nodes, thereby leaving the N-ary tree with a depth n_{MCM}, the number of state vectors simultaneously stored on the memory is n_{MCM}+1 or below. This is a memory saving compared to the conventional deferred measurement technique for which the number of state vectors simultaneously stored on the memory is 2^{nMCM}>n_{MCM}+1 for n_{MCM}>1. The proposed tree traversal technique thereby increases the performances of the computing device.

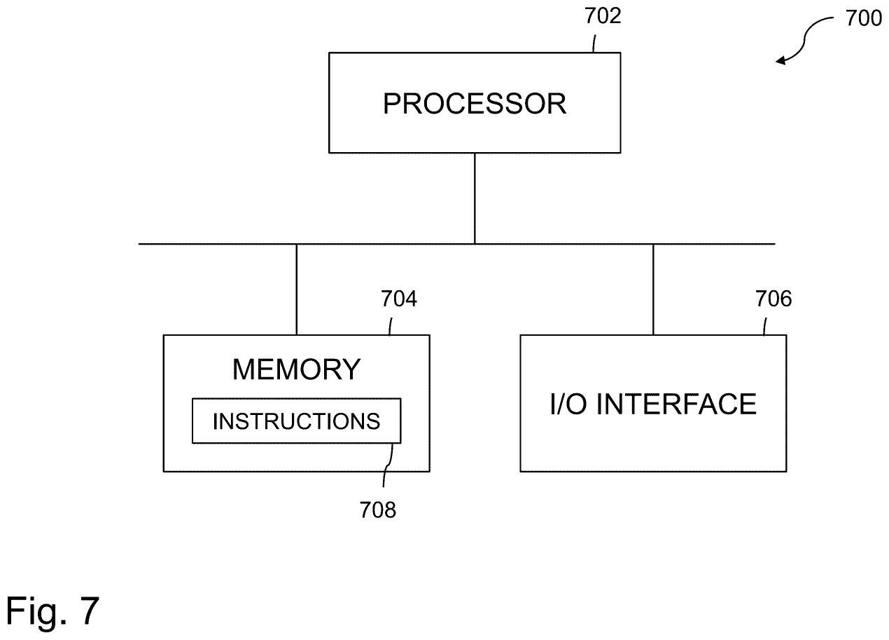

Referring now to FIG. 7, the computing device traversing the N-ary tree can be provided as a combination of hardware and software components. The hardware components can be implemented in the form of a computing device 700, an example of which is described with reference to FIG. 7. The computing device 700 can have a processor 702, a memory 704, and I/O interface 706. Instructions 708 for traversing an N-ary tree in accordance with the tree traversal technique disclosed herein can be stored on the memory 704 and accessible by the processor 702.

The processor 702 can be, for example, a general-purpose microprocessor or microcontroller, a digital signal processing (DSP) processor, an integrated circuit, a field-programmable gate array (FPGA), a reconfigurable processor, a programmable read-only memory (PROM), a programmable logic controller (PLC), or any combination thereof.

The memory 704 can include a suitable combination of any type of computer-readable memory that is located either internally or externally such as, for example, random-access memory (RAM), read-only memory (ROM), compact disc read-only memory (CDROM), electro-optical memory, magneto-optical memory, erasable programmable read-only memory (EPROM), electrically-erasable programmable read-only memory (EEPROM), Ferroelectric RAM (FRAM), or the like.

Each I/O interface 706 enables the computing device 700 to interconnect with one or more input devices, such as a keyboard(s), mouse(s), or with one or more output devices such as monitor(s), internal or external memory system(s), and internal or external communication network(s).

Each I/O interface 706 enables the controller to communicate with other components, to exchange data with other components, to access and connect to network resources, to server applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fibre optics, satellite, mobile, wireless (e.g. Wi-Fi, WiMAX), SS7 signaling network, fixed line, local area network, wide area network, and others, including any combination of these.

The computing device 700 and any software application that can be run by the computing device 700 are meant to be examples only. Other suitable embodiments of the controller can also be provided, as will be apparent to the skilled reader.

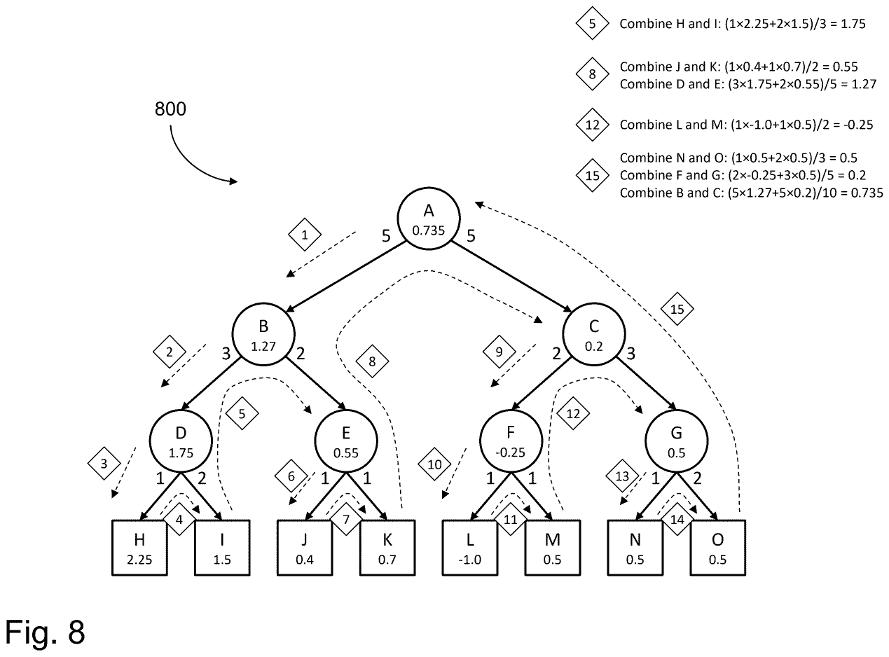

An example binary tree 800 having n_{MCM}=3 is shown in FIG. 8. With reference to the binary tree 800, an example of how terminal measurements are combined is presented. As shown, a plurality of samples is inputted at the root node A. Each of the root node A and the internal nodes B through G have a respective left and right count determining which sample(s) of the plurality of samples is(are) routed towards which child nodes, depending on the outcome of the mid-circuit measurement. For instance, the root node A has 5 and 5 as left and right counts, respectively. In this instance, it means that 5 samples are routed towards child node B and 5 samples are routed towards internal node C. As another example, the internal node D has 1 and 2 as left and right counts, respectively. In this situation, 1 sample is routed towards leaf node H whereas 2 samples are routed towards leaf node I. This logic can be applied throughout the whole binary tree 800. Now, having discussed how the state vectors are stored and/or cleared from the memory above with reference to FIGS. 3 and 4, the following addresses the terminal measurements, their combinations, and when the terminal measurements can be stored and/or cleared from the memory.

The tree traversal technique discussed above dictates that the binary tree 800 is traversed straight to a first one of the leaf nodes, i.e., the leaf node H, where a first terminal measurement TM_{H} is made. Then, the traversing involves going back up the binary tree 800 and then straight through a second one of the leaf nodes, i.e., leaf node I, where a second terminal measurement TM_{I} is made. At this stage, the terminal measurements TM_{H} and TM_{I} of the two leaf nodes H and I are combined with one another to form TM_{H+I}, which can allow the memory to be cleared from the state vectors SV_{H} and SV_{I} and of the terminal measurements TM_{H} and TM_{I} associated with the two leaf nodes H and I. As depicted in this figure, the combined terminal measurement TM_{H+I} is shown within the internal node D which is parent to leaf nodes H and I (see diamond numbered 5). Then, the traversing involves going back up the binary tree 800 and straight through another one of the leaf nodes, i.e., leaf node J, where a terminal measurement TM_{J} is made. At this stage, the traversing involves going back up the binary tree 800 and then straight through a neighboring one of the leaf nodes, i.e., leaf node K, where a terminal measurement TM_{K} is made. At this stage, the terminal measurements TM_{J} and TM_{K} of the two leaf nodes J and K are combined with one another to form TM_{J+K}, which can allow the memory to be cleared from the state vectors SV_{J} and SV_{K} and of the terminal measurements TM_{J} and TM_{K} associated with the two leaf nodes J and K. As depicted in this figure, the combined terminal measurement TM_{J+K} is shown within the internal node E which is parent to leaf nodes J and K (see diamond numbered 8). The tree traversal involves going back up the tree through another one of the leaf nodes, during which the combined terminal measurements TM_{H+I} and TM_{J+K} can be combined with one another. The resulting combined terminal measurement TM_{H+I+J+K} is shown within internal node B. The tree traversal then involves going back up the binary tree 800 and then straight to another one of the leaf nodes, and so forth, until the whole binary tree 800 has been traversed, and all of the combined terminal measurements have been combined to yield TM_{H+I+J+K+L+M+N+O} as shown within root node a.

In this specific embodiment, the terminal measurements are provided in the form of expectation values. In such embodiments, the combination of the terminal measurements can correspond to a weighted sum based on the left and right count of the corresponding node. For instance, as shown in FIG. 8, the terminal measurements TM_{H} and TM_{I} are expectation values of 2.25 and 1.5, respectively. As the left and right counts of the internal node D are 1 and 2, respectively, the combined terminal measurement TM_{H+I} can be given by (1×2.25+2×1.5)/3=1.75. Similarly for the leaf nodes J and K, the terminal measurements TM_{J} and TM_{K} are expectation values of 0.4 and 0.7, respectively. As the left and right counts of the internal node E are 1 and 1, respectively, the combined terminal measurement T_{J+K} can be given by (1×0.4+1×0.7)/2=0.55. When the combined terminal measurements TM_{H+I} and TM_{J+K} are combined, it is performed based on the left and right counts of the internal node B, which are 3 and 2. Accordingly, the combined terminal measurement TM_{H+I+J+K} is given by (3×1.75+2×0.55)/5=1.27. Moreover, as shown in FIG. 8, the terminal measurements TM_{L} and TM_{M} are expectation values of −1.0 and 0.5, respectively. As the left and right counts of the internal node F are 1 and 1, respectively, the combined terminal measurement T_{L+M} can be given by (1×−1.0+1×0.5)/2=−0.25. Similarly for the leaf nodes N and O, the terminal measurements TM_{N} and TM_{O} are expectation values of 0.5 and 0.5, respectively. As the left and right counts of the internal node G are 1 and 2, respectively, the combined terminal measurement T_{N+O} can be given by (1×0.5+2×0.5)/3=0.5. Now, as all of the individual terminal measurements have been made, and even combined, the tree traversal involves going back up the tree towards root node A while combining all of the previously combined terminal measurements. For instance, the combined terminal measurement TM_{L+M+N+O} is given by (2×−0.25+3×0.5)/5=0.2, and the combined terminal measurement TM_{H+I+J+K+L+M+N+O} is given by (5×1.27+5×0.2)/10=0.735, as shown within the root node A.

Although the above example relies on expectation values for the terminal measurements, it is intended that the terminal measurements can include, but are not limited to, counts, mean, probability, sample, or variance of/from an object. These objects may include observables (Hermitian operators such as Pauli matrices), wires (e.g., probabilities of observing either state on qubit 5 and 7), or MCMs and their composition (e.g., classical processing of MCMs like summing, multiplying, or producing a list of MCMs). An example of an expectation value is the Pauli-Z expectation value. However, in some other embodiments, other types of expectation values can be used (e.g., Pauli-X, Pauli-Y, a tensor product of Pauli operators, etc.). Moreover, other weighted or unweighted combination types can be performed. For instance, in some embodiments, the combination does not correspond to a weighted sum but to a direct sum (e.g., in the case of counts), to a concatenation (e.g., in the case of samples), or to a computation based on the expectation values of the square of the observable and the observable itself (e.g., in the case of variance).

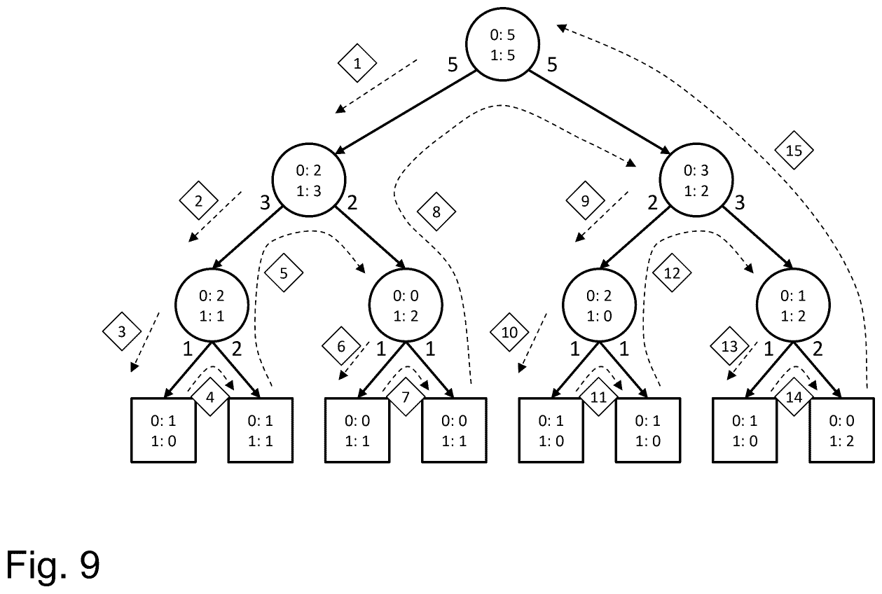

FIG. 9 shows another terminal measurement combination example. More specifically, if terminal measurements are counts(wire=1) (i.e., the number of times state 0 or state 1 is observed for qubit #1), combinations can be performed as a direct sum for each outcome.

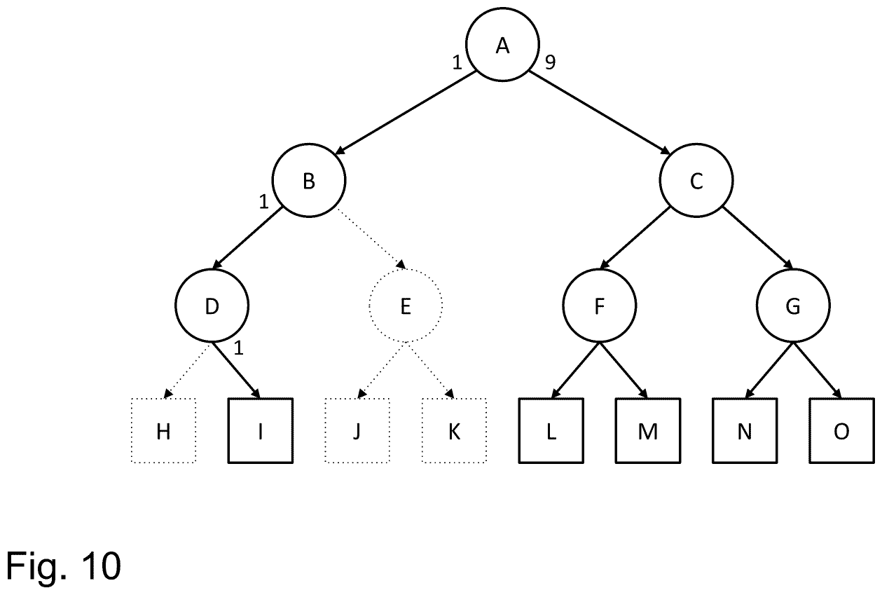

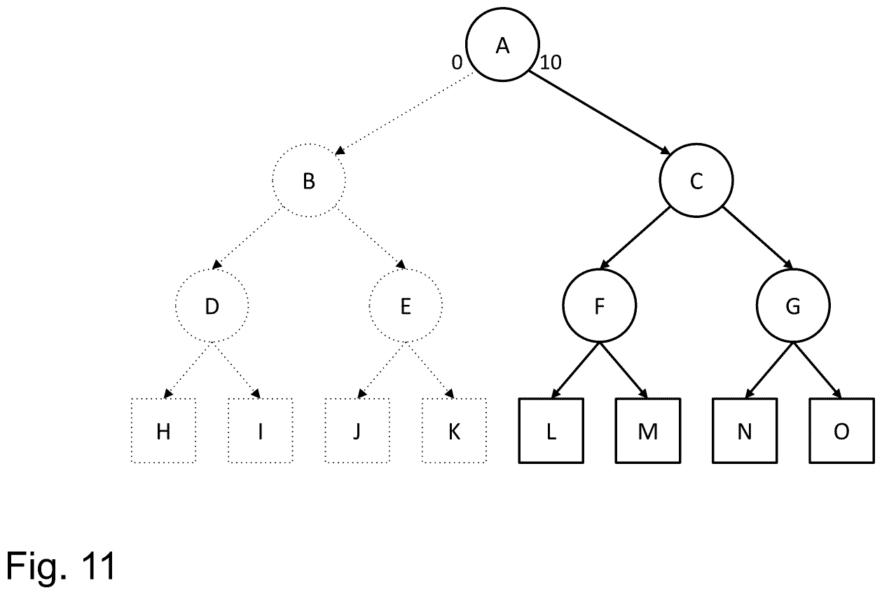

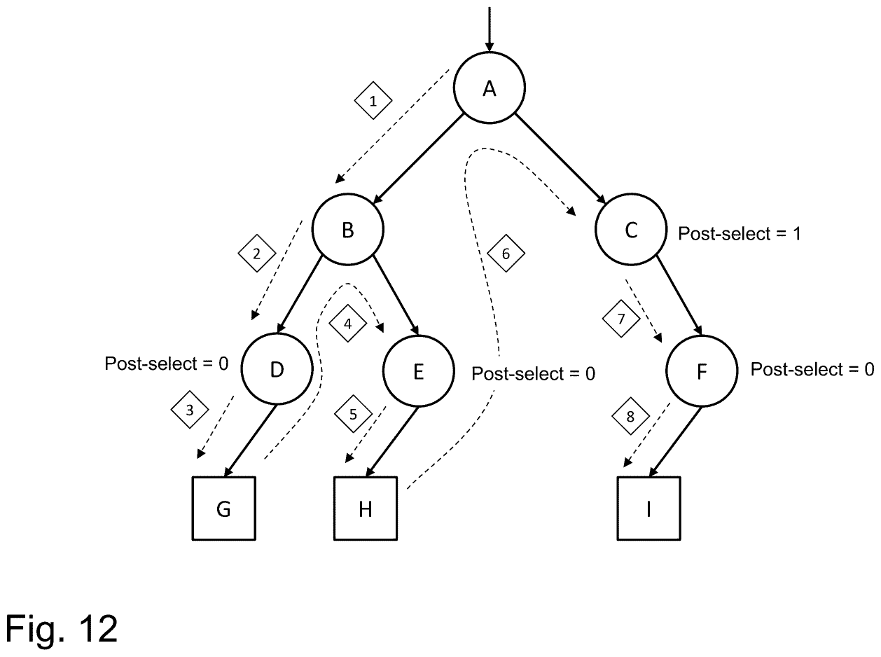

In some embodiments, the tree traversal method proposed herein may omit the traversing of some of the branches of the N-ary tree upon determining that one of the root or internal nodes receives a null count towards one of its child nodes. For instance, and referring now to FIG. 10, internal node B has a left and right count of 1 and 0, respectively. In this instance, the tree traversal method omits the right branch of the internal node B altogether, thus saving computational time and memory. Similarly, internal node D has a left and right count of 0 and 1, respectively. In this instance, the tree traversal method omits the left branch of the internal node D. This can be referred to as dynamic tree pruning because the branches with counts of zero are discovered at runtime. FIG. 11 shows another example where the root node A receives a left and right count of 0 and 10, respectively. In this embodiment, the left branch of the whole binary tree can be omitted, thereby saving computational time and memory. In some other embodiments, such as shown in FIG. 12, some nodes are programmed with a post-select value. In these instances, regardless of the left and right count, some branches of the binary tree can be omitted. It is noted that post-selection for a given MCM is usually the same on all branches, but this is not always the case. Here, the second MCM (nodes B and C) has no post-selection on the left (0) branch, but post-selects 1 on the right (1) branch.

Still referring to FIG. 12, at each node/MCM, all samples are collected at once. This removes the need to run the same quantum circuit several times (as is done in the “shot-by-shot” (OS) prior art technique). MCMs can post-select on a specific measurement outcome, effectively acting as filters. For example, for a Pauli-Z basis MCM with two possible outcomes {0, 1}, post-selecting for 0 effectively removes the branch corresponding to the outcome of 1 from the tree. Therefore, the tree traversal algorithm reduces the required calculation load by a factor of two for every such MCM. This is referred to as static tree pruning because the post-selection rules would be known at compile time. Such static tree pruning cannot be leveraged by the OS implementation, and can further be used to reduce memory requirements by the deferred measurement (DF) implementation only if the post-selection is static and the same on all branches. For instance, if one post-selected 0 instead of 1 at node B, the memory savings would be the same for the tree traversal implementation, but would be lost for the deferred measurement implementation. In practice, many counts at the branches of MCMs come out to be zero, meaning those branches can be removed from the rest of the simulation. It is therefore possible to reduce the computational requirements, for example, by a factor of two for each MCM in the Pauli-Z basis.

As depicted in FIG. 12, the algorithm first reaches a leaf (i.e., terminal measurement) at node G. As soon as this happens, it is possible to free all memory associated with the state vector on edge D-G. The results at node D can be trivially combined since it has a single non-trivial branch and then all memory associated with the state vector on edge B-D can be freed. Walking back up the tree, combining terminal measurements, all memory can be reclaimed except for that of one state vector, at which point the circuit on the sub-tree corresponding to the 1 outcome at the first MCM can be simulated. This is why at most n_{MCM}+1 state vector copies are needed at any given time. By analogy, the deferred measurement method explores all branches simultaneously, requiring exponentially more memory to reach the terminal measurements.

The tree traversal technique proposed herein can give the best of both worlds. Compared to the naive OS implementation, it significantly reduces the overheads and duplicate work associated with running the same circuit many times. In the limit of a few shots and/or several MCMs, it is at least as fast as the naive OS implementation thanks to dynamic tree pruning. Compared to the DF implementation, it reduces memory usage exponentially, as well as computational cost (in the large MCM number limit). In the limit of many shots and/or few MCMs, it is equal to or faster than the deferred measurement algorithm (albeit with more overheads in practice) because each tree edge is visited at most once.

The tree traversal technique proposed herein has several additional benefits and advantages:

It can generalise to generic MCMs. Dynamic circuit implementations are often limited to measuring in the computational basis, but this algorithm lends itself to measurements on any basis, including measurements of multi-qubit observables, by adjusting the number of branches per node.

The capacity of measuring generic observables can enable simulating noisy circuits by introducing interactions with the environment in lieu of MCMs, i.e., regarding MCMs as noise channels. The TT algorithm can constitute an efficient, low-memory alternative to mixed-state simulators, the state-of-the-art technique to simulate noise in quantum circuits. The advantages of the TT method compared with mixed-state simulators are analogous to its advantages compared with state vector simulators (exponentially lower memory requirements and static/dynamic tree pruning).

Contrary to the shot-by-shot (OS) algorithm, the TT algorithm can be generalizable to an analytic treatment of MCMs and measurements, working with probabilities instead of counts at the tree nodes. While the exponential memory savings come for free, dynamic tree pruning is not automatic in the analytic framework. It can be restored by introducing a cutoff for marginal probabilities which enables controlling which subtrees are important. Note that a cutoff can be similarly applied to the counts in the finite shot setting, allowing for tuning of the “greediness” of dynamic tree pruning.

The introduction of a cutoff can enable yet another improvement: adaptive tree traversal. In this scheme, a user can set a tolerance on the precision of the results and TT can iteratively explore lower and lower probability branches as prescribed by lowering the cutoff. This can greatly improve efficiency in unbalanced trees with many non-zero but unlikely outcomes. For example, a user may set a desired precision and the simulation can be run with a first cutoff. A second cutoff lower than the first cutoff can then be set and TT can traverse more branches (i.e., those that didn't pass the first cutoff but do pass the second cutoff). If the measurement results change by an amount less than the desired precision, the simulation ends. Otherwise, the process is repeated with further iterations until the desired precision is acquired.

Described above is a TT algorithm requiring n_{MCM}+1 state vector copies. A low-memory version using a single state vector is also possible. Simply put, by exploring the tree starting from the top every time, one can trade computation time for memory. It is also possible to implement a fixed-memory version whereby a fixed-size stack of state vectors is used to store the state vectors at a few MCM nodes, reducing the depth of circuit re-execution by a commensurate factor.

The TT algorithm, in particular the low-memory variants, generates embarrassingly parallel workloads since many branches can be simulated in parallel. It is thus amenable to high-performance computing (HPC) implementation and optimization.

As can be understood, the examples described above and illustrated are intended to be exemplary only. The scope is indicated by the appended claims.

What is claimed is:

1. A computer-implemented method for traversing an N-ary tree simulating a quantum circuit, the N-ary tree having a root node A, internal nodes B and C, and leaf nodes D and E child to internal node B, the root node A and internal nodes B and C corresponding to mid-circuit measurements of the quantum circuit and the leaf nodes D and E corresponding to terminal measurements of the quantum circuit, the method comprising:
from the root node A, traversing the N-ary tree through the internal node B towards the leaf node D, including storing, on a memory of a computing device, a state vector SV_{A} at root node A, a state vector SV_{B} at internal node B, a state vector SV_{D} at leaf node D, and a terminal measurement TM_{D} associated to the state vector SV_{D};
from the leaf node D, traversing the N-ary tree through the internal node B towards leaf node E, including: clearing, from the memory, the state vector SV_{D}; and
storing, on the memory, a state vector SV_{E} at leaf node E, and a terminal measurement TM_{E} associated to the state vector SV_{E}; and
from the leaf node E, traversing the N-ary tree through the internal node B and root node A towards internal node C, including: storing, on the memory, a combined terminal measurement TM_{D+E} corresponding to a combination of the terminal measurements TM_{D} and TM_{E}; clearing, from the memory, the state vectors SV_{E} and SV_{B}; and storing, on the memory, a state vector SV_{C} at internal node C.

2. The method of claim 1 further comprising, after said storing the combined terminal measurement TM_{D+E}, clearing, from the memory, the terminal measurements TM_{D} and TM_{E}.

3. The method of claim 1, wherein the N-ary tree has leaf nodes F and G child to internal node C, the method further comprising: from the internal node C, traversing the N-ary tree towards the leaf node F, including: storing, on the memory, a state vector SV_{F} at leaf node F, and a terminal measurement of TM_{F} associated to the state vector SV_{F}.

4. The method of claim 3 further comprising: from the leaf node F, traversing the N-ary tree through the internal node C towards leaf node G, including: clearing, from the memory, the state vector SV_{F}; and storing, on the memory, a state vector SV_{G} at leaf node G, and a terminal measurement of TM_{G} associated to the state vector SV_{G}.

5. The method of claim 4 wherein said traversing includes: storing, on the memory, a combined terminal measurement TM_{F+G} corresponding to a combination of the terminal measurements TM_{F} and TM_{G}; and clearing, from the memory, the state vectors SV_{G} and SV_{C}.

6. The method of claim 5 wherein said traversing includes: storing, on the memory, a combined terminal measurement TM_{D+E+F+G} corresponding to a combination of the combined terminal measurements TM_{D+E} and TM_{F+G}; and clearing, from the memory, the state vector SV_{A}.

7. The method of claim 1 wherein the quantum circuit processes n qubits, each state vector representing a 2ⁿ-dimensional vector to be stored on the memory, each state vector including complex numbers having real and imaginary parts.

8. The method of claim 1 wherein the N-ary tree has a depth n_{MCM} of 2, a number of state vectors simultaneously stored on the memory being 3 or below.

9. The method of claim 1 wherein the N-ary tree further includes one or more additional layers of internal nodes, thereby leaving the N-ary tree with a depth n_{MCM}, a number of state vectors simultaneously stored on the memory being n_{MCM}+1 or below.

10. The method of claim 1 further comprising inputting a plurality of samples at the root node, each of the root node and the internal nodes having a respective left and right count determining which sample(s) of the plurality of samples is(are) routed towards which child nodes.

11. The method of claim 10 wherein when the terminal measurements are expectation values, each combination corresponds to a weighted sum, the weighted sum based on the left and right count of the corresponding node.

12. The method of claim 1 wherein when the terminal measurements are counts, each combination corresponds to a direct sum.

13. The method of claim 1 wherein upon determining that one of the root node A, the internal node B, and the internal node C receives a null count towards one of the child nodes, omitting the traversing of the N-ary tree through the child node and traversing the N-ary tree through the other one of the child nodes.

14. The method of claim 1 wherein the N-ary tree is a binary tree.

15. A computing device for traversing an N-ary tree simulating a quantum circuit, the N-ary tree having a root node A, internal nodes B and C, and leaf nodes D and E child to internal node B, the root node A and the internal nodes B and C corresponding to mid-circuit measurements of the quantum circuit and the leaf nodes D and E corresponding to terminal measurements of the quantum circuit, the computing device comprising:
a processor; and
a computer-readable memory having stored thereon instructions which when executed by the processor perform the steps of:
from the root node A, traversing the N-ary tree through the internal node B towards the leaf node D, including storing, on a memory of a computing device, a state vector SV_{A} at root node A, a state vector SV_{B} at internal node B, a state vector SV_{D} at leaf node D, and a terminal measurement TM_{D} associated to the state vector SV_{D};
from the leaf node D, traversing the N-ary tree through the internal node B towards leaf node E, including: clearing, from the memory, the state vector SV_{D}; and storing, on the memory, a state vector SV_{E} at leaf node E, and a terminal measurement TM_{E} associated to the state vector SV_{E}; and
from the leaf node E, traversing the N-ary tree through the internal node B and root node A towards internal node C, including: storing, on the memory, a combined terminal measurement TM_{D+E} corresponding to a combination of the terminal measurements TM_{D} and TM_{E}; clearing, from the memory, the state vectors SV_{E} and SV_{B}; and storing, on the memory, a state vector SV_{C} at internal node C.

16. A computer-implemented method for traversing an N-ary tree simulating a quantum circuit, the N-ary tree having a root node, a plurality of layers of internal nodes, and leaf nodes child to a downstream one of the layers of internal nodes, the root node A and the plurality of layers of internal nodes corresponding to a plurality of mid-circuit measurement layers of the quantum circuit, and the leaf nodes corresponding to terminal measurements of the quantum circuit, the method comprising:
from a first internal node of a downstream one of the layers of internal nodes, traversing the N-ary tree towards a first one of the leaf nodes, including storing, on a memory of a computing device, a state vector SV₁ at the first one of the leaf nodes, and a terminal measurement TM₁ associated to the state vector SV₁;
from the first one of the leaf nodes, traversing the N-ary tree through the first internal node towards a second one of the leaf nodes, including: clearing, from the memory, the state vector SV₁; and storing, on the memory, a state vector SV₂ at the second one of the leaf nodes, and a terminal measurement TM₂ associated to the state vector SV₂; and
from the second one of the leaf nodes, traversing the N-ary tree through the first internal node towards a second internal node of the downstream one of the layers of internal nodes, including: storing, on the memory, a combined terminal measurement TM₁₊₂ corresponding to a combination of the terminal measurements TM₁ and TM₂; clearing, from the memory, the state vector SV₂; and storing, on the memory, a state vector SV₃ at the second internal node.

17. The method of claim 16 wherein the quantum circuit processes n qubits, each state vector representing a 2ⁿ-dimensional vector to be stored on the memory, each state vector including complex numbers having real and imaginary parts.

18. The method of claim 16 wherein the N-ary tree has a depth n_{MCM}, corresponding to a number of edges from the root node to one of the leaf nodes, a number of state vectors simultaneously stored on the memory being n_{MCM}+1 or below.

19. The method of claim 16 further comprising inputting a plurality of samples at the root node, each of the root node and the internal nodes having a respective left and right count determining which sample(s) of the plurality of samples is(are) routed towards which child nodes.

20. The method of claim 19 wherein when the terminal measurements are expectation values, each combination corresponds to a weighted sum, the weighted sum based on the left and right count of the corresponding node.
